(19) United States
(12) Patent Application Publication
(10) Pub. No.: US 2007/0179981 A1
(43) Pub. Date: Aug. 2, 2007

(54) Efficient data management in a cluster file system

(75) Inventor: Pradeep Vincent, Bellevue, WA (US)

Correspondence Address: LAW OFFICE OF DAN SHIFRIN, PC - IBM, 14081 WEST 59TH AVENUE, ARVADA, CO, 80004, US

(73) Assignee: International Business Machines Corporation, Armonk, NY (US)

(21) Appl. No.: 11/343,305

(22) Filed: Jan. 31, 2006

(51) Int. Cl. G06F 17/30

(52) U.S. Cl. 707/200

(57) ABSTRACT

Methods and systems manage datasets in a cluster file system. A request is received from a client to perform a file system operation on a specified dataset stored in one of a plurality of nodes in a cluster. The specified dataset is retrieved from a first node through a backbone switch and stored in a cache in a second node. The requested file system operation is performed on the specified dataset and, upon completion of the requested operation, metadata is modified to indicate that the specified dataset is stored in the second node. The specified dataset is not returned through the backbone switch to the first node.

### TECHNICAL FIELD

The present invention is directed generally to the storage of digital information in a cluster file system and, in particular, to the efficient use of inter-node bandwidth.

### BACKGROUND ART

A cluster file system allows multiple servers to access the same files using independent paths to data storage. A group of independent nodes are interconnected through a backbone switch and work together as a single system. Users (clients) are provided with access to all files located on the storage devices in the system using common file system paths. In one cluster file system, each node is configured into two virtual servers, a front-end server and a back-end server. The location of datasets on the various servers is maintained in metadata. A request by a client for an operation on a specified dataset may be received by any node in the cluster. By accessing the metadata, the specified dataset may be located on one of the virtual servers (or on one of the nodes if the nodes are not configured with virtual servers). The write data is then typically stored by the receiving node in a cache in that node. Upon completion of the operation, the modified dataset is flushed out of the cache and sent to its original location. If the original location is on a virtual server in a node other than the receiving node, the dataset must be transferred across the backbone switch, consuming backbone resources and bandwidth.

### SUMMARY OF THE INVENTION

The present invention provides a cluster file system accessible to clients through a network. The file system comprises a plurality of file system nodes in a cluster, including a first node and a second node, a backbone switch interconnecting the first node and the second node and a metadata structure identifying the node on which datasets are stored. The first node comprises a first cache and a dataset controller. The dataset controller is configured to, if a specified dataset is stored on the second node, receive a request from a client to perform a file system operation on the specified dataset, access the metadata structure to determine the node on which the specified dataset is stored, retrieve through the backbone switch from the second node that a first portion of the specified dataset to which the file system operation is directed and leave a remainder portion of the specified dataset stored in the second node, store the retrieved first portion in the first cache and upon completion of the file system operation, modify the metadata structure to indicate that at least the first portion of the specified dataset is stored in the first node, whereby the first portion is not returned through the backbone switch to the second node.

The present invention further provides a method for managing datasets in a cluster file system. The method comprises receiving a request from a client to perform a file system operation on a specified dataset stored in one of a plurality of nodes in a cluster, retrieving the specified dataset from a first node through a backbone switch, storing the retrieved specified dataset in a cache in a second node, performing the requested file system operation on the specified dataset and, upon completion of the requested operation, modifying metadata to indicate that the specified dataset is stored in the second node, whereby the specified dataset is not returned through the backbone switch to the first node.

The present invention further provides a computer program product of a computer readable medium usable with a programmable computer and having computer-readable code embodied therein for managing datasets in a cluster file system. The computer-readable code comprising instructions for receiving a request from a client to perform a file system operation on a specified dataset stored in one of a plurality of nodes in a cluster, retrieving the specified dataset from a first node through a backbone switch, storing the retrieved specified dataset in a cache in a second node, performing the requested file system operation on the specified dataset and, upon completion of the requested operation, modifying metadata to indicate that the specified dataset is stored in the second node, whereby the specified dataset is not returned through the backbone switch to the first node.

The present invention further provides a file system node in a multi-node cluster file system. The node comprises means for interconnecting the node to at least a second node through a backbone switch, a cache, a metadata structure identifying the node on which datasets are stored, means for receiving a request from a client to perform a file system operation on a specified dataset, means for accessing the metadata structure to determine the node on which the specified dataset is stored, means for retrieving through the backbone switch that first portion of the specified dataset to which the file system operation is directed and leaving a remainder portion of the specified dataset stored in the second node if the specified dataset is stored on the second node, means for storing the retrieved first portion in the first cache and means for modifying the metadata structure upon completion of the file system operation to indicate that at least the first portion of the specified dataset is stored in the first node, whereby the first portion is not returned through the backbone switch to the second node.

### BRIEF DESCRIPTION OF THE DRAWINGS

FIG. 1 is a block diagram of a cluster file system in which the present invention may be implemented;

FIG. 2 is a block diagram of one configuration of a node of the cluster file system of FIG. 1;

FIGS. 3A-3C are sequential functional block diagrams of one embodiment of a cluster file system of the present invention in which the location of an entire dataset is transferred from one node to another;

FIG. 4 is a flowchart of a method of the embodiment of the present invention illustrated in FIGS. 3A-3C;

FIGS. 5A-5C are sequential functional block diagrams of initial dataset processing in which a dataset is dividable into subsets;

FIG. 6 is a flowchart of a method of the embodiment of the present invention illustrated in FIGS. 5A-5C;

FIGS. 7A and 7B continue from the sequential functional block diagrams of FIGS. 5A-5C and illustrate an embodiment of a cluster file system of the present invention in which the subsets are reassembled in one node;

FIG. 8 is a flowchart of a method of the embodiment of the present invention illustrated in FIGS. 7A and 7B;

FIG. 9 continues from the sequential functional block diagrams of FIGS. 5A and 5B and illustrates another embodiment of a cluster file system of the present invention in which the ultimate locations of the subsets are split between two nodes;

FIG. 10 is a flowchart of a method of the embodiment of the present invention illustrated in FIG. 9;

FIGS. 11A-11C continue from the sequential functional block diagrams of FIGS. 5A and 5B and illustrate an embodiment of the present invention in which the subsets are rejoined in their original node location during a period of reduced activity of the backbone switch; and

FIG. 12 is a flowchart of a method of the embodiment of the present invention illustrated in FIGS. 11A-11C.

### DETAILED DESCRIPTION OF THE PREFERRED EMBODIMENT

FIG. 1 is a block diagram of a cluster file system 100 in which the present invention may be implemented. The system 100 includes clients 110 and a plurality of nodes. For clarity, two nodes 120 and 200 are illustrated and included in the description; however, the system 100 may include additional nodes and the scope and operation of the present invention do not depend upon the number of nodes. A backbone switch 130 couples the nodes 200 and 120, herein referred to as Node 1 and Node 2, respectively, enabling datasets to be transferred between the nodes 200 and 120.

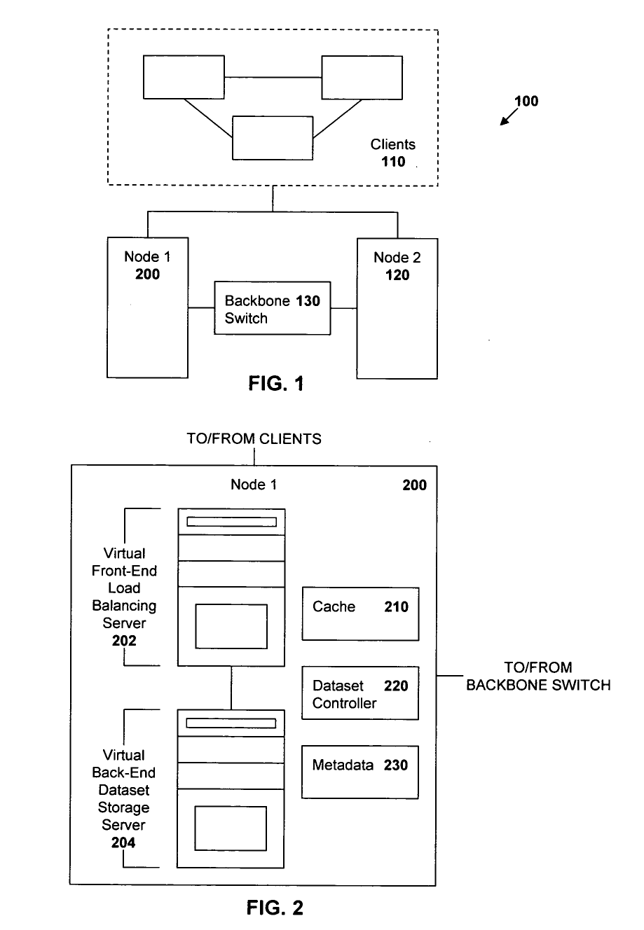

FIG. 2 is a block diagram of one configuration of Node 1 200; it will be appreciated that the other node(s) may have the same or similar configuration. Node 1 200 has been configured to include two virtual servers, a front-end load balancing sever 202 and a back-end dataset storage server 204. The front-end server 202 receives file system requests from clients, determines the appropriate node to which the request is to be routed and decides when and how to flush the cache. The back-end server 204 manages the datasets and provides a locking/leasing mechanism for the front-end server to use. In addition, Node 1 200 includes a memory cache 210, a dataset controller 220 and storage for dataset metadata 230. For each dataset stored in the cluster file system 100, the metadata 230 identifies its location in a virtual server (if the nodes are so configured) or in a node (if virtual servers are not used).

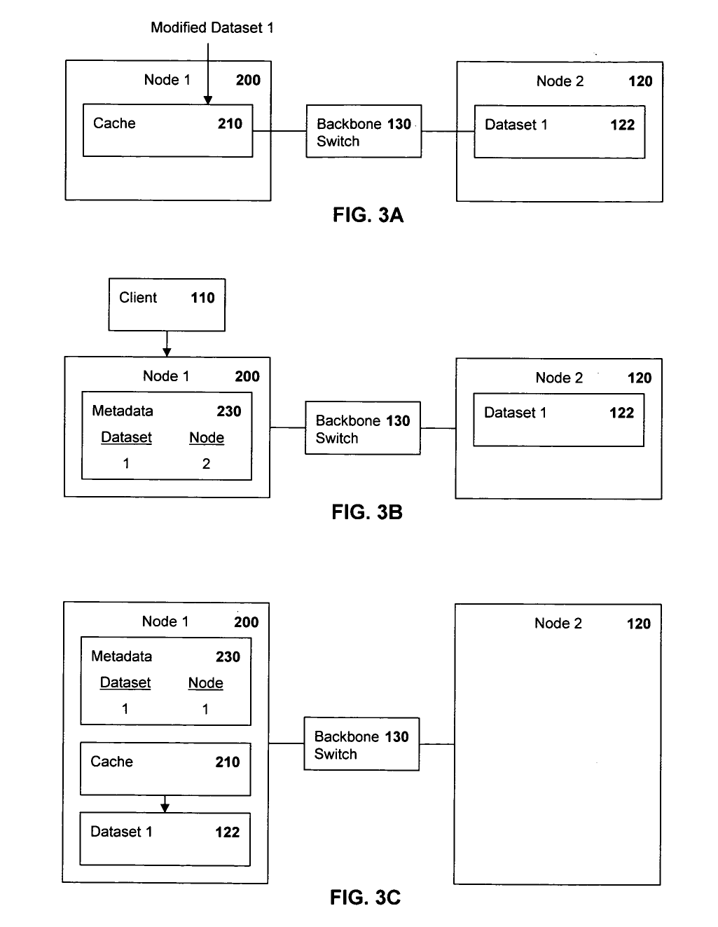

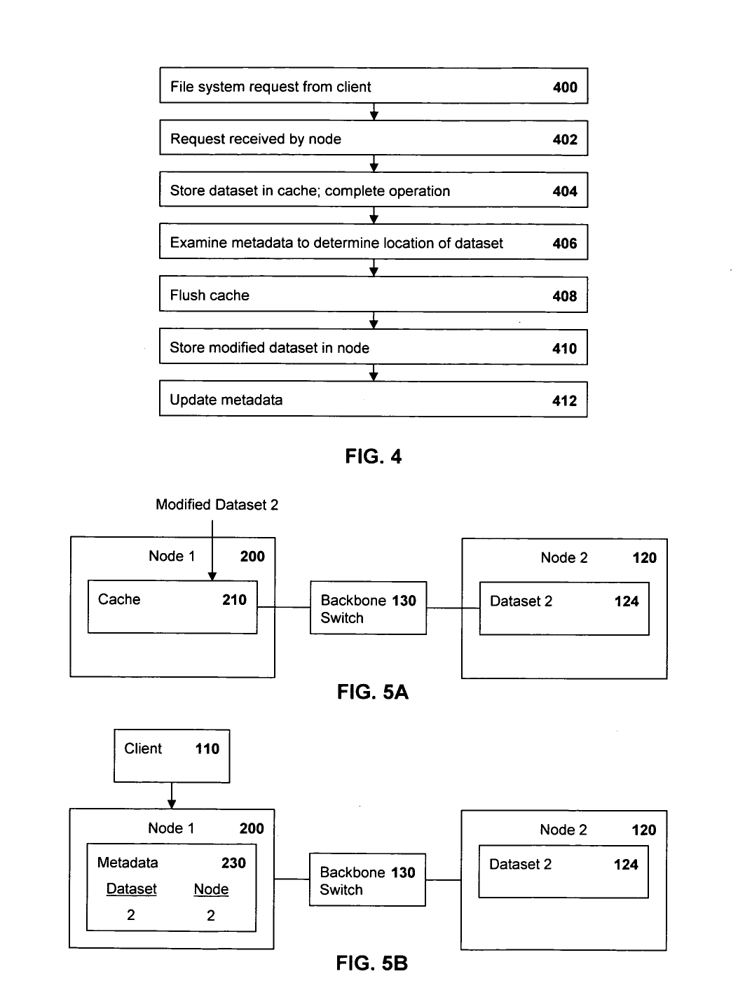

Turning now to the block diagrams of FIGS. 3A-3C and the flow chart of FIG. 4, the operation of one embodiment of the present invention will be described. When a file system request is sent by a client 110 (step 400), such as a write operation on a specified dataset, the request is received by one of the nodes 200, 120. For purposes of this description, it will be assumed that the request is received by Node 1 200 (step 402). The write data or modified data is stored in the cache 210 (FIG. 3A; step 404). The dataset controller 220 determines from the metadata 230 the location of the specified dataset on which the operation is to be performed (step 406). For example, the metadata 230 may indicate that the specified dataset is dataset 1 122 and is located in Node 2 120 (FIG. 3B).

In a conventional cluster file system, upon completion of the requested operation, cache 210 would be flushed and the modified dataset 122 would be transferred through the backbone switch 130 to Node 2 120 to be stored. However, in order to reduce bandwidth usage through the backbone switch 122, in the embodiment of the present invention illustrated in FIGS. 3A-3C, the cache 210 is instead flushed (step 408) and the modified dataset 122 stored in Node 1 200 (step 410). The metadata 230 is updated (step 412) to reflect the new location (FIG. 3C).

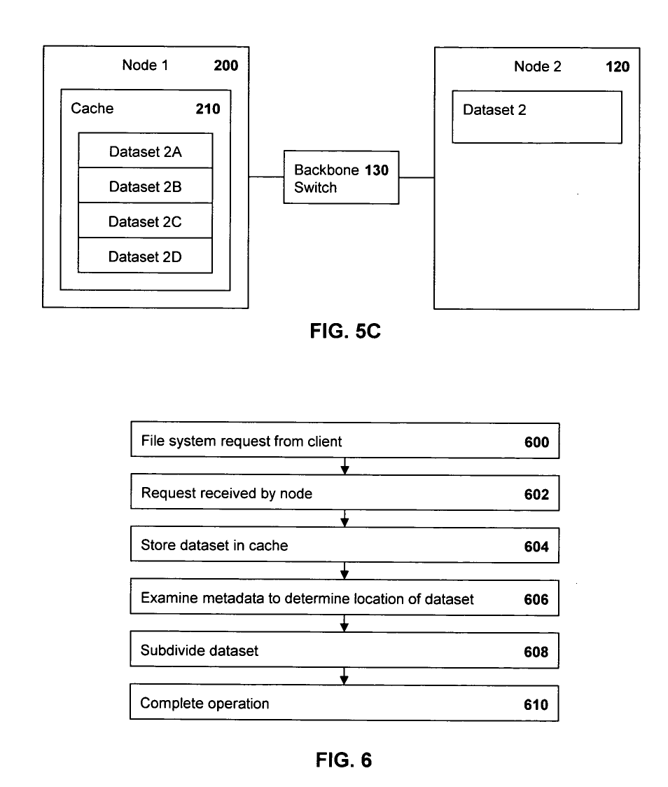

FIGS. 5A-5C and the accompanying flowchart of FIG. 6 illustrate the initial dataset processing during another embodiment of the present invention. As in the previous embodiment, when a file system request is sent by a client 110 (step 600), the request is received by one of the nodes 200, 120. For purposes of this description, it will again be assumed that the request is received by Node 1 200 (step 602). The write or modified data is stored in the cache 210 (FIG. 5A; step 604). The dataset controller 220 determines from the metadata 230 the location of the dataset on which the operation is to be performed (step 604). For example, the metadata 230 may indicate that the specified dataset is dataset 2 124 and is located in Node 2 120 (FIG. 5B). If the dataset 2 124 is large relative to the aggregate write size, it may be subdivided into subsets (FIG. 5C; step 608). For example, the size of the dataset 2 124 may be 8 GB but the requested file operation pertains to only 6 GB. The dataset 2 124 may then be divided into four subsets DS-2A-DS-2D in the cache 210 in Node 1 200 (FIG. 5C). Once creation of the subsets DS-2A-DS-2D has been performed in the cache 210, the requested file system operation may be completed (step 610).

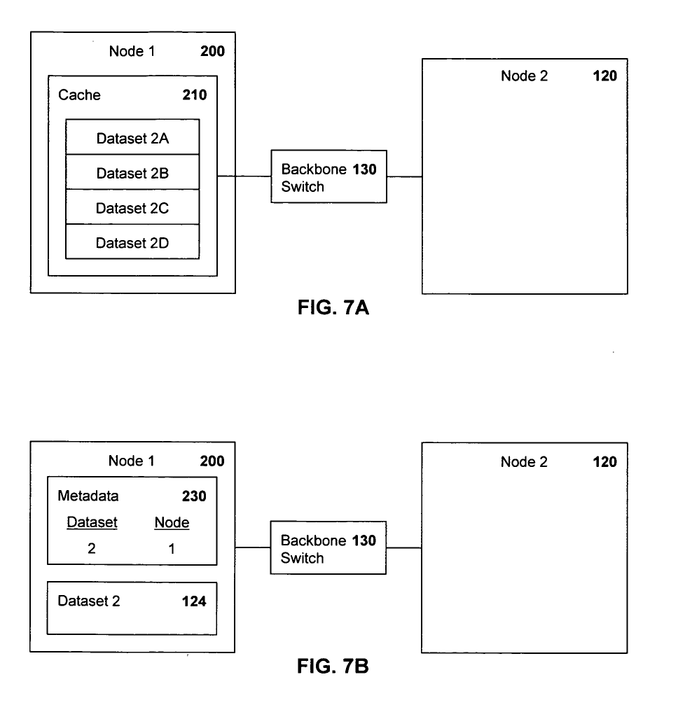

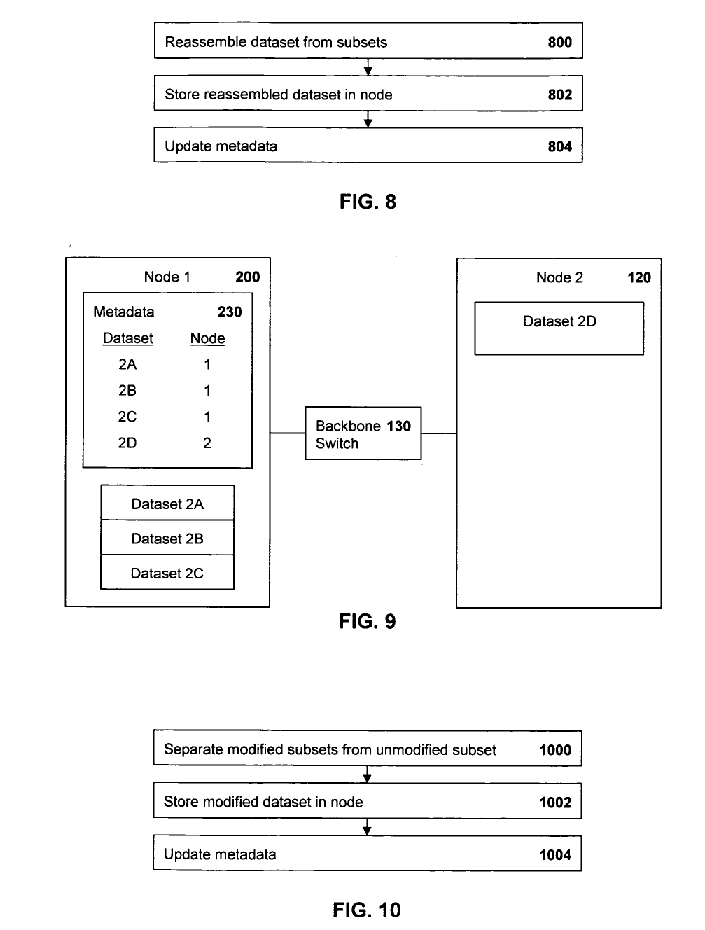

The present invention provides several alternatives for processing the subsets following their processing in accordance with the requested file system operation. FIGS. 7A and 7B and the flowchart of FIG. 8 illustrate one such alternative. Rather than transfer the modified subsets DS-2A-DS-2C through the backbone switch 130 from Node 1 200 to Node 2 120, it is a more efficient use of backbone resources to reassemble the subsets DS-2A-DS-2D of dataset 2 124 (FIG. 7A; step 800) and store it in Node 1 200 (step 802). The metadata 230 is then updated to reflect that the dataset 2 124 is now stored in Node 1 200 (step 804; FIG. 7B).

FIG. 9 and the flowchart of FIG. 10 illustrate another alternative. Rather than transfer the modified subsets DS-2A-DS-2C through the backbone switch 130 from Node 1 200 to Node 2 120 (thereby using backbone bandwidth and resources), the modified subsets DS-2A-DS-2C are separated from the remaining subset DS-2D (step 1000) and then flushed from the cache 210 into storage in Node 1 200 (step 1002) while the other subset DS-2D remains in Node 2 120. The metadata 230 is updated to reflect the new location of subsets DS-2A-DS-2C and the location of subset DS-2D (step 1004).

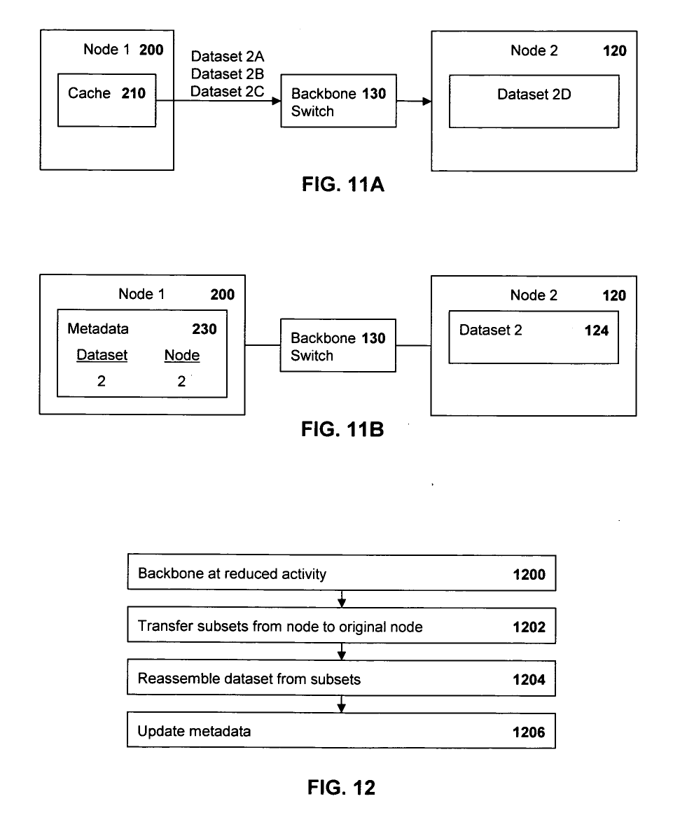

In still a further embodiment of the present invention, illustrated in the block diagrams of FIGS. 11A and 11B and the flowchart of FIG. 12, if the subsets DS-2A-DS-2C have been stored in Node 1 as described with respect to FIGS. 9 and 10, they may be reassembled with subset DS-2D in Node 2 during a period in which the backbone switch 130 is idle or otherwise at a reduced activity level (step 1200); that is, when the backbone switch 130 is idle or the full backbone bandwidth is otherwise not being used. Thus, the subsets DS-2A-DS-2C may be transferred back through the backbone switch 130 (FIG. 11A; step 1202) to be joined with the remaining subset DS-2D (step 1204). The metadata 230 is then updated to reflect the change in location of the subsets DS-2A-DS-2C and the reassembly of dataset 2 (FIG. 11B; step 1206).

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies regardless of the particular type of signal bearing media actually used to carry out the distribution. Examples of computer readable media include recordable-type media such as a floppy disk, a hard disk drive, a RAM, and CD-ROMs and transmission-type media such as digital and analog communication links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. Moreover, although described above with respect to methods and systems, the need in the art may also be met with a computer program product containing instructions for managing datasets in a cluster file system.

What is claimed is:

1. A cluster file system accessible to clients through a network, comprising:
a plurality of file system nodes in a cluster, including a first node and a second node;
a backbone switch interconnecting the first node and the second node;
a metadata structure identifying the node on which datasets are stored; and
the first node comprising a first cache and a dataset controller configured to, if a specified dataset is stored on the second node:
receive a request from a client to perform a file system operation on the specified dataset;
access the metadata structure to determine the node on which the specified dataset is stored;
retrieve through the backbone switch from the second node that a first portion of the specified dataset to which the file system operation is directed and leave a remainder portion of the specified dataset stored in the second node;
store the retrieved first portion in the first cache; and
upon completion of the file system operation, modify the metadata structure to indicate that at least the first portion of the specified dataset is stored in the first node, whereby the first portion is not returned through the backbone switch to the second node.

2. The system of claim 1, wherein:
the first node and the second node each comprise a virtual front-end server and a virtual back-end server; and
the metadata structure identifies the virtual server and the node on which datasets are stored.

3. The system of claim 1, wherein the dataset controller is further configured to:
upon completion of the file system operation, retrieve through the backbone switch the remainder portion of the specified dataset;
modify the metadata structure to indicate that the entire specified dataset is stored in the first node; and
store the entire specified dataset in the first node.

4. The system of claim 1, wherein the dataset controller is further configured to:
divide the specified dataset into a plurality of subsets, each having a size wherein the first portion and the remainder portion of the specified dataset each comprise at least one subset;
modify the metadata structure to indicate that subsets comprising the first portion are stored in the first node and subsets comprising the remainder portion are stored in the second node; and
store the subsets of the first portion in the first node.

5. The system of claim 4, wherein the dataset controller is further configured to, during a time in which the backbone switch is at a reduced level of activity:
transfer the subsets comprising the first portion from the first node through the backbone switch to the second node;
combine the at least one subset of the first portion with the at least one subset of the remainder portion to reform the specified dataset;
store the reformed specified dataset in the second node; and
modify the metadata structure to indicate that the specified dataset is stored in the second node.

6. The system of claim 1, wherein the dataset controller is further configured to, during a time in which the backbone switch is at a reduced level of activity:
transfer the first portion from the second node through the backbone switch to the first node;
combine the first portion with the remainder portion to reform the specified dataset;
store the reformed specified dataset in the first node; and
modify the metadata structure to indicate that the specified dataset is stored in the first node.

7. A method for managing datasets in a cluster file system, comprising:
receiving a request from a client to perform a file system operation on a specified dataset stored in one of a plurality of nodes in a cluster;
retrieving the specified dataset from a first node through a backbone switch;
storing the retrieved specified dataset in a cache in a second node;
performing the requested file system operation on the specified dataset; and
upon completion of the requested operation, modifying metadata to indicate that the specified dataset is stored in the second node, whereby the specified dataset is not returned through the backbone switch to the first node.

8. The method of claim 7, wherein:
the file system operation is requested to be performed on a first portion of the specified dataset; and
retrieving the specified dataset comprises retrieving the first portion through the backbone switch whereby a second portion remains stored in the first node.

9. The method of claim 8, wherein modifying the metadata comprises modifying the metadata to indicate that the first portion of the specified dataset is stored in the second node and the second portion is stored in the first node.

10. The method of claim 8, wherein:
the method further comprises dividing the specified dataset into a plurality of subsets wherein the first portion and the second portion each comprise at least one subset; and
modifying the metadata comprises modifying the metadata to indicate that subsets comprising the first portion are stored in the second node and subsets comprising the second portion are stored in the first node.

11. The method of claim 10, further comprising, during a time in which the backbone switch is at a reduced level of activity:
transferring the at least one subset of the first portion from the second node through the backbone switch to the first node;
combining the at least one subset of the first portion with the at least one subset of the second portion to reform the specified dataset;
storing the reformed specified dataset in the first node; and
modifying the metadata structure to indicate that the specified dataset is stored in the first node.

12. The method of claim 7, further comprising, during a time in which the backbone switch is at a reduced level of activity:
transferring the first portion from the second node through the backbone switch to the first node;
combining the first portion with the second portion to reform the specified dataset;
storing the reformed specified dataset in the first node; and
modifying the metadata structure to indicate that the specified dataset is stored in the first node.

13. A computer program product of a computer readable medium usable with a programmable computer, the computer program product having computer-readable code embodied therein for managing datasets in a cluster file system, the computer-readable code comprising instructions for:
receiving a request from a client to perform a file system operation on a specified dataset stored in one of a plurality of nodes in a cluster;
retrieving the specified dataset from a first node through a backbone switch;
storing the retrieved specified dataset in a cache in a second node;
performing the requested file system operation on the specified dataset; and
upon completion of the requested operation, modifying metadata to indicate that the specified dataset is stored in the second node, whereby the specified dataset is not returned through the backbone switch to the first node.

14. The computer program product of claim 13, wherein:
the file system operation is requested to be performed on a first portion of the specified dataset; and
the instructions for retrieving the specified dataset comprise instructions for retrieving the first portion through the backbone switch whereby a second portion remains stored in the first node.

15. The computer program product of claim 14, wherein:
the instructions further comprise instructions for dividing the specified dataset into a plurality of subsets wherein the first portion and the second portion each comprise at least one subset; and
the instructions for modifying the metadata comprise instructions for modifying the metadata to indicate that subsets comprising the first portion are stored in the second node and subsets comprising the second portion are stored in the first node.

16. The computer program product of claim 15, further comprising instructions for, during a time in which the backbone switch is at a reduced level of activity:
transferring the at least one subset of the first portion from the second node through the backbone switch to the first node;
combining the at least one subset of the first portion with the at least one subset of the second portion to reform the specified dataset;
storing the reformed specified dataset in the first node; and
modifying the metadata structure to indicate that the specified dataset is stored in the first node.

17. The computer program product of claim 13, further comprising instructions for, during a time in which the backbone switch is at a reduced level of activity:
transferring the first portion from the second node through the backbone switch to the first node;
combining the first portion with the second portion to reform the specified dataset;
storing the reformed specified dataset in the first node; and
modifying the metadata structure to indicate that the specified dataset is stored in the first node.

18. A file system node in a multi-node cluster file system, comprising:
means for interconnecting the node to at least a second node through a backbone switch;
a cache;
a metadata structure identifying the node on which datasets are stored;
means for receiving a request from a client to perform a file system operation on a specified dataset;
means for accessing the metadata structure to determine the node on which the specified dataset is stored;
if the specified dataset is stored on the second node, means for retrieving through the backbone switch that first portion of the specified dataset to which the file system operation is directed and leaving a remainder portion of the specified dataset stored in the second node;
means for storing the retrieved first portion in the first cache; and
means for modifying the metadata structure upon completion of the file system operation to indicate that at least the first portion of the specified dataset is stored in the first node, whereby the first portion is not returned through the backbone switch to the second node.

19. The file system node of claim 18, further comprising:
means for retrieving through the backbone switch the remainder portion of the specified dataset upon completion of the file system operation;
modifying the metadata structure to indicate that the entire specified dataset is stored in the first node; and
storing the entire specified dataset in the first node.

20. The file system node of claim 18, further comprising:
means for dividing the specified dataset into a plurality of subsets, each having a size wherein the first portion and the remainder portion of the specified dataset each comprise at least one subset;
means for modifying the metadata structure to indicate that subsets comprising the first portion are stored in the first node and subsets comprising the remainder portion are stored in the second node; and
means for storing the subsets of the first portion in the first node.

21. The file system node of claim 18, further comprising:
means for transferring the first portion from the second node through the backbone switch to the first node during a time in which the backbone switch is at a reduced level of activity;
means for combining the first portion with the remainder portion to reform the specified dataset;
means for storing the reformed specified dataset in the first node; and
means for modifying the metadata structure to indicate that the specified dataset is stored in the first node.
